(19) United States
(12) Patent Application Publication
(10) Pub. No.: US 2006/0250732 A1
(43) Pub. Date: Nov. 9, 2006

(54) Transient pulse, substrate-triggered biCMOS rail clamp for ESD abatement

(76) Inventor: Nathaniel M. Peachey, Peyton, CO (US)

Correspondence Address: SCHNECK & SCHNECK, P.O. BOX 2-E, SAN JOSE, CA, 95109-0005, US

(21) Appl. No.: 11/123,305

(22) Filed: May 6, 2005

(51) Int. Cl. H02H 9/00

(52) U.S. Cl. 361/56

(57) ABSTRACT

A circuit for protecting a circuit device against electrostatic discharge (ESD), power line, and voltage supply line surges. A transistor, diode, resistor, and capacitor are configured to clamp voltage pulses between the power and ground lines. The circuit is constructed using a single bipolar npn transistor formed using an isolated p-well.

### TECHNICAL FIELD

This invention relates generally to the protection of integrated circuits from electrostatic discharge (ESD) and voltage pulses.

### BACKGROUND ART

Electrostatic discharge (ESD) and voltage pulses may cause internal damage to integrated circuits. An ESD event may be caused by a voltage swing or unstable power supply voltage, or contact with an ungrounded human being having a static charge. An ESD event may cause, for example, the gate of an MOS device to break down or rupture, resulting in current leakage and failed integrated circuit operation. In addition, current trends to smaller design geometries and sub-micron devices tend to increase integrated circuit device sensitivity to ESD events and voltage pulses.

The device of FIG. 1A uses a CMOS device but a CMOS device has the disadvantage of not sinking enough current to fully protect or provide the desired level of the ESD or voltage pulse protection for sub-micron devices. The device of FIG. 1B uses an SCR circuit capable of sinking more current, but an SCR circuit will exhibit a relatively high voltage trigger that may exceed the voltage failure level of some sub-micron devices. Also, an ESD event or voltage pulse may cause an irreversible triggering event, causing the SCR to latch up. Another protection method, as disclosed by U.S. Pat. No. 6,442,008 to Anderson and entitled “Low Leakage Clamp for ESD Protection,” in FIG. 1C, uses a Darlington transistor pair or Darlington transistor string. However, with a Darlington pair operating in an off state (normal operation), the leakage current may increase as the temperature of the integrated circuit being protected increases.

Some ESD protection circuits use “snapback” devices. Snapback devices operate by allowing a voltage to rise to a break down voltage point before “snapping back” to clamp an ESD event or voltage pulse. Generally, during normal operation, a snapback device behaves similarly to a regular Zener diode with the difference that when an applied voltage exceeds a defined trigger voltage, the current voltage characteristics of the snapback device will decrease or snapback to sink the same or a higher amount of current at a lower “snapback” voltage. The circuit is disclosed by U.S. Pat. No. 5,223,737 to Canclini and is entitled “Electrostatic Discharge Device for an Integrated Circuit Pad and Related Integrated Structure.” The circuit of Canclini, shown in FIG. 1D, uses a Zener diode to trigger a protective transistor. However, in protecting integrated circuits and devices manufactured using sub-micron technologies, the trigger voltage of a Zener diode or a snapback device may also be too high for sub-micron devices to tolerate before failure. Furthermore, snapback devices may have significant parasitic capacitance making them unusable in some high frequency applications.

### SUMMARY OF THE INVENTION

An exemplary embodiment of the present invention provides a protection circuit for an integrated circuit. The protection circuit protects devices in the integrated circuit from an electrostatic discharge (ESD) or voltage pulse present on a power distribution line or supply voltage line. The protection circuit incorporates a bipolar transistor, a capacitor, and a resistor. The capacitor is electrically coupled to a voltage supply line (or power distribution line) of the integrated circuit and is coupled to, or in series with, a resistor that is electrically coupled to a voltage reference line (or ground). For the transistor in the circuit, the base of the transistor is electrically coupled to the junction between the capacitor and resistor. The transistor's collector is electrically coupled to the voltage supply line and the transistor's emitter is electrically coupled to the voltage reference line. Additionally, a diode is electrically coupled between the voltage supply line and the voltage reference of the integrated circuit, having its anode electrically coupled to the voltage supply line and its cathode electrically coupled to the voltage reference line.

One advantage of using a bipolar transistor in conjunction with non-bipolar devices or submicron technologies is the protection circuit can carry significant currents to protect the integrated circuit. The protection circuit operates or turns-on based on the fast rise time of an electrostatic discharge or a voltage pulse through the capacitor. Another advantage of using the above described protection circuit of the present invention is the clamping voltages are lower in comparison with a snapback device.

### BRIEF DESCRIPTION OF THE DRAWINGS

FIGS. 1A-D are schematic diagrams of conventional ESD protection circuits.

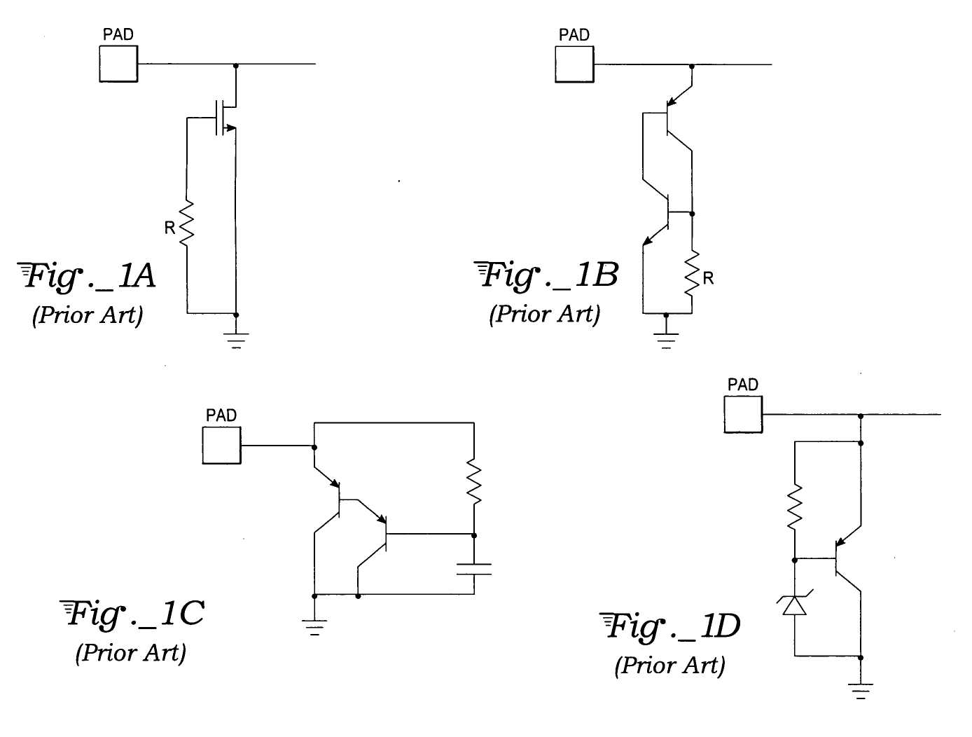

FIGS. 2A-B are schematic diagrams of exemplary over-voltage protection circuits.

FIG. 3 is a cross sectional diagram of an exemplary integrated circuit having a bipolar over-voltage protection circuit.

FIG. 4 is a turn-on curve for the protection circuit of FIGS. 2 and 3 under transient ESD-like conditions.

FIG. 5 is a leakage curve for the bipolar over-protection circuit of FIGS. 2 and 3.

### DETAILED DESCRIPTION OF THE INVENTION

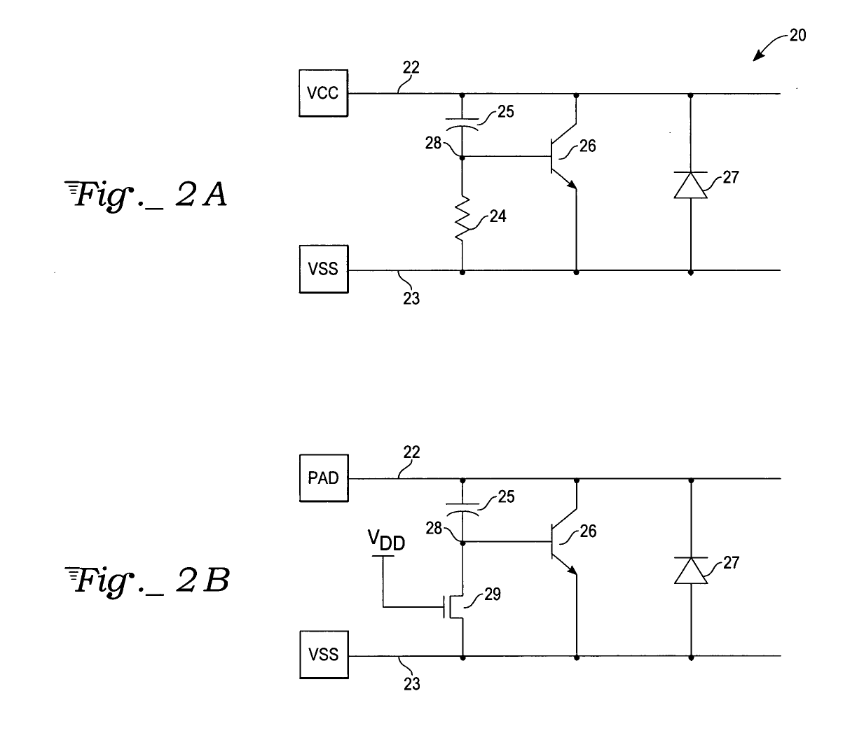

Referring to FIG. 2A, a voltage supply line 22 and a voltage reference line 23 or ground line provides voltage and power for an integrated circuit configured as an exemplary over-voltage protection circuit 20. A first terminal of a capacitor 25 is electrically coupled to the voltage supply line 22, and a second terminal of the capacitor 25 is electrically coupled to a first node 28. A first terminal of a resistor 24 is electrically coupled to the first node 28, and a second terminal of the resistor 24 is electrically coupled to the voltage reference line 23.

A single bipolar npn transistor 26 having a collector, emitter, and base, is electrically coupled to the voltage supply line 22, the voltage reference line 23, and the first node 28. The collector of the transistor 26 is electrically coupled to the voltage supply line 22, the emitter of the transistor 26 is coupled to the voltage reference line 23, and the base of the transistor 26 is electrically coupled to the first node 28. The base of the transistor 26, electrically coupled to the first node 28, is also electrically coupled to the capacitor 25 and the resistor 24. A diode 27 has its anode electrically coupled to the voltage reference line 23 and its cathode electrically coupled to the voltage supply line 22. The diode 27 may also be any equivalent p-n junction, for example, a transistor (not shown) configured with its base electrically coupled to its collector or emitter.

In an alternate embodiment, in FIG. 2B, the protection circuit incorporates a switching device 29, replacing the resistor 24 in FIG. 2A. For example, the switching device may be an NMOS transistor having its control gate coupled to a supply voltage line. This specific embodiment (in FIG. 2B) may be used as a stand-alone ESD protection circuit for a pad in an integrated circuit.

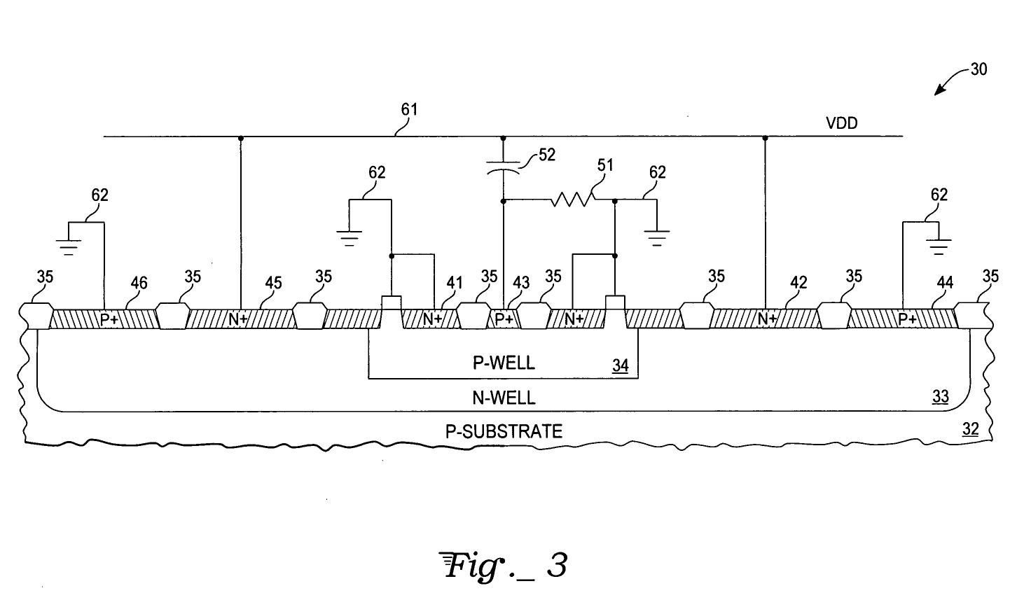

The over-voltage protection circuit 20 in FIG. 2A may be fabricated as an integrated circuit to protect devices and circuitry from electrostatic discharges or voltage pulses. Referring to FIG. 3, an exemplary structure 30 of the over-voltage protection circuit 20 includes an n-well region 33 (n-well), formed in a p-type substrate 32. An isolated p-well region 34 (p-well) is formed in the n-well 33. Mask layers are generally used to develop the n-well and p-well regions. An oxide layer is formed above the n-well 33 and p-well 34. The oxide layer is used to create electrical isolation features 35. Additional steps are used to form or open contact windows to the n-well and p-well regions, and to form additional n-type and p-type regions to develop contacts and other device features.

Next, after the contact windows are formed, a first n-type region 41, contacting the p-well 34, is formed to establish an emitter region of a single bipolar lateral npn transistor. A second n-type region 42 contacting the n-well 33 is formed to establish a collector region of the transistor, and a first p-type region 43 contacting the p-well 34 is formed to establish a base region of the transistor. A second p-type region 44 contacting the n-well 33 is formed to establish an anode region of a diode, and either a third n-type region (not shown) is formed or the second n-type region 42 contacting the n-well 33, is used to establish a cathode region of the diode. Additionally, an optional second diode may be formed in other portions of the n-well. For example, an additional p-type region 46 contacting the n-well 33 may be formed to establish an anode region of a second diode, and an additional n-type region 45 may be formed contacting the n-well 33 to establish a cathode region of the second diode.

In additional steps, a patterned metallization layer (not shown), a resistor 51, and a capacitor 52 are formed. The resistor 51 is formed having a first terminal electrically coupled to the first p-type region 43 (the base region of the transistor) and a second terminal is electrically coupled both to a portion of a conductive layer 62 to be used as a common voltage reference line or ground. The resistor 51 may be a passive or active component. A passive resistor can be formed from diffusion area isolated by a field oxide. Typically, an nwell region is used with n+ active connections on each side of the resistor. Alternatively, the resistor can be made from a poly process. Typically the poly is unsilicided except for the ends at which the resistor is contacted. An active resistor may also be formed using a MOS device. Typically, it is an NMOS device with its gate tied to the voltage supply line. In an ESD event, the NMOS transistor is initially in the off state and provides a high resistance. As the supply rail increases due to the ESD voltage, the turning on of the transistor lags the ESD pulse to a transient, high-resistive element.

The capacitor 52 is formed having a first terminal electrically coupled to the first p-type region 43 (the base region of the transistor) and a second terminal electrically coupled to a portion of the metallization layer 61 to be used as a power voltage line (or power rail). The capacitor can be formed using a variety of methods. One method is generally known as a MOScap. A MOScap in the same manner that a transistor is formed, however, the source and drain are shorted together and, with the transistor well, form one plate of the capacitor. The other plate of the capacitor is formed by a poly that corresponds to the gate of the transistor. Another method of forming a capacitor is to use two poly layers of a double poly process. In this example, a first layer of poly is deposited and it becomes the bottom plate of the capacitor. An oxide is then grown over the first poly layer. Next, a second poly deposition is used as the top plate. After a pattern and etch processes, the capacitor is defined by this poly/oxide/poly structure. A third example of forming a capacitor is to form two layers and an inter-layer dielectric (ILD) between the two metal layers as the separation dielectric. A final example of forming a capacitor structure uses a metal-insulator-metal (MIM) process. A metal layer is coated with a thin dielectric layer and then covered with a second metal layer. The second metal layer may be the capping layer normally used over metal lines. Patterning and etching this structure provides its structured definition.

The n-well 33 is electrically coupled to a portion of the metallization layer 61 to be used as a power voltage line, thus electrically coupling the collector region of the transistor and electrically coupling the cathode region of the diode to the power or supply voltage line. The p-well 34 is electrically coupled to a portion of the a conductive layer 62 to be used as a common voltage reference line or ground, thus electrically coupling the emitter region of the transistor and the anode region of the diode to the common voltage reference line or ground. The optional second diode anode region (fabricated around p-type region 46) may be coupled to the common voltage reference line or ground (i.e., the conductive layer 62), and the second diode cathode region (i.e., the n-type region 45) may be coupled to the supply voltage line (i.e., the metallization layer 61).

Referring again to FIG. 2A, in a case where the exemplary over-voltage protection circuit 20 circuit 20 is electrically coupled between the voltage supply line 22 (or power supply line) and the reference line 23 (or ground line), only one protective circuit (e.g., a single transistor, capacitor, resistor, and diode) is needed to protect an entire integrated circuit. In addition, the over-voltage protection circuit 20 may be used as a rail clamp in a pad network or coupled between a variety of integrated circuit voltage lines or input/output lines to protect the integrated circuit from electrostatic discharge or voltage pulses.

The transistor 26 in the over-voltage protection circuit 20 is off during normal operating conditions when there are no ESD events or voltage pulses. During a positive voltage ESD event or during a positive voltage pulse, the transistor 26 turns on when the ESD event or voltage pulse occurs. The capacitor 25 electrically passes the voltage pulse (or ESD) to the transistor 26, biases the transistor 26 base, and turns the transistor 26 on. When the transistor 26 is on, the transistor 26 is in a conduction state, sinking ESD or voltage pulse current from the supply voltage line 22 to the reference voltage line 23 (or ground), thus protecting other transistors and circuits in the integrated circuit (not shown) from the ESD event or voltage pulse. During a negative voltage ESD event or during a negative voltage pulse, the diode 27 becomes forward biased, is in a conducting state, and protects other transistors and circuits in the integrated circuit from the negative ESD event or negative voltage pulse.

The response time when an ESD event or voltage pulse occurs for the protection circuit may be predetermined by the values of the resistor 24 and capacitor 25. In a specific exemplary embodiment, the value for the resistor 24 is generally within a range of 5 Kohms to 50 Kohms, and the value for the capacitor 25 is generally within a range of 200 fempto farads to 10 pico farads, although a broad range of the resistor 25 and the capacitor 24 values may be used to implement any desired or selected RC time constant. Since exemplary capacitance ranges are between 200 fF to 10 pF and exemplary resistor ranges are between 5 Kohms to 50 Kohms, this defines an RC time constant range from approximately 1 nsec to 500 nsec. The lowest value is well below the time constant where the RC trigger is expected to be effective and the upper value is well above the time period of the typical ESD pulse. Another RC time constant range for the protection circuit may be selected, for example, from 20 microseconds to 100 microseconds. If the exemplary over-voltage protection circuit 20 is applied to other signal or input/output lines in the integrated circuit, the RC time constant may be selected to accommodate the frequency requirements of those signals or signal lines.

Referring again to the exemplary structure in FIG. 3, implementing the isolated p-well 34 and the n-well 33 structure described above, the isolated p-well 34 is formed that is biased during an ESD event or voltage pulse. Biasing the isolated p-well 34, which serves as the base region of the bipolar lateral npn transistor, turns the transistor on and clamps current from the ESD or voltage pulse to the conductive layer 62 (ground). The capacitor 52 and the resistor 51 network supply the charge needed to bias the isolated p-well 34 and turn the transistor on. In addition, the surrounding n-well 33 is tied to the supply voltage line, providing a positive bias to the n-well 33. A diode is also formed in the n-well 33, providing a clamp for negative voltage ESD events or negative voltage pulses.

A transmission line pulse (TLP) ESD test is used to test the circuit and confirm the protective operation of the circuit. A TLP tester generates a rectangular pulse with energy ranges similar to those used in a human body model (HBM) ESD qualification test and generally uses very short ESD pulses having nanosecond rise times and nanosecond pulse widths and provides an output showing the current and voltage data of the over-voltage protection circuit 20 (FIG. 2).

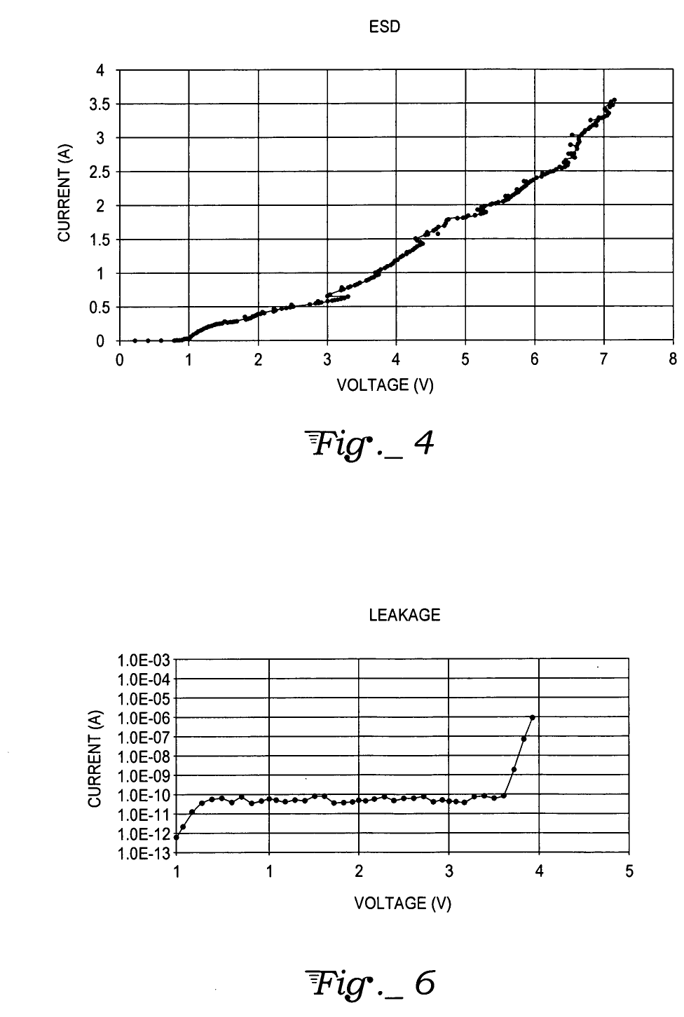

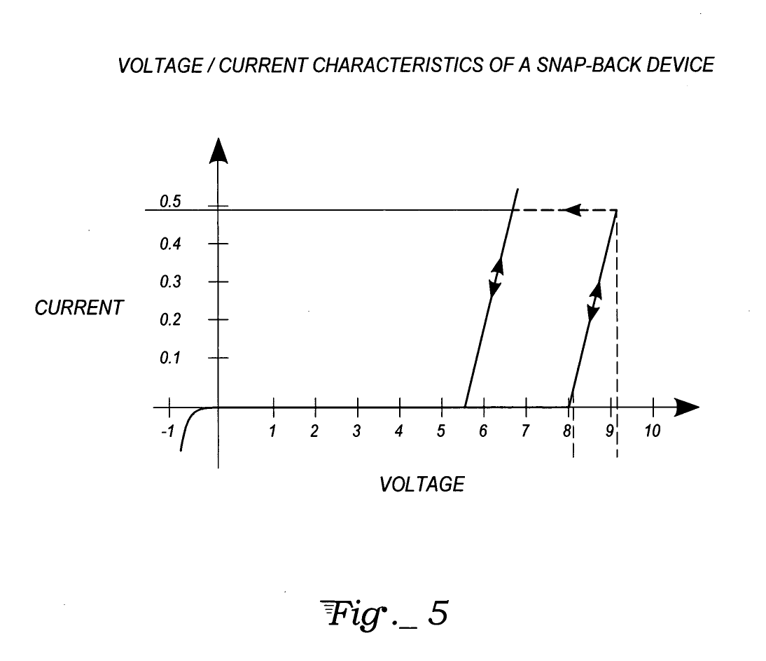

With reference to FIG. 4, a typical turn on response curve for the exemplary over-voltage protection circuit 20, tested under transient ESD conditions and characterized using a transmission line pulse (TLP) test displays test results. The response curve indicates that the over-voltage protection circuit 20 begins to clamp at voltages that are lower than other circuits such as a snapback device. In addition, the gradual upward curve (from approximately one volt and higher) indicates smooth transistor turn-on characteristics in comparison to, for example, the turn-on characteristics of a typical Zener diode or a snapback device shown in FIG. 5.

FIG. 5 shows the leakage characteristics for the exemplary over-voltage protection circuit 20 coupled to a power or voltage supply line of 3.3 volts. When the transistor 26 is off, the structure has very low leakage characteristics (at approximately 0.1 nanoamps) below the supply line voltage, and the standby leakage is lower than many prior art designs (not shown). For example, in comparison, a snapback device, a leakage current in the approximate range of 30 to 100 nanoamps in a 0.5 to 3.5 volt range. Circuit activation or transistor conduction of the over-voltage protection circuit 20 is evidenced by the current increase above approximately 3.5 volts.

Presented in this invention is a circuit used to protect an integrated circuit or other device from electrostatic discharge (ESD) or voltage pulses. Those of skill in the art will recognize that the invention can be practiced with modification and alteration within the spirit and scope of the appended claims and many other embodiments will be apparent to those of skill in the art upon reading and understanding the description presented herein. For example, the circuit described above may be electrically coupled between any of the following integrated circuit functions or nodes: 1) a voltage or power supply line, 2) a voltage reference line, or 3) an input/output pad or other circuit element. In addition, the circuit may be electrically coupled between voltage supply lines, between voltage reference lines, or between input/output pads or between circuit elements. Also, a skilled artisan will realize that the invention may be fabricated in other ways (e.g., with vertical bipolar devices or prp devices) or even with discrete components. Therefore, the description is thus to be regarded as illustrative instead of limiting.

What is claimed is:

1. A protection circuit to protect an electronic circuit from an electrostatic discharge or voltage pulse, the protection circuit comprising:
a transistor device having a control region and a controlled conductance region, the controlled conductance region having a first contact region and a second contact region configured to be controlled by the control region to operate in a conductive or non-conductive state, the first contact region of the transistor electrically coupled to a voltage supply line, the second contact region of the transistor electrically coupled to a voltage reference line, and the control region of the transistor electrically coupled to a first node;
a capacitor having a first terminal electrically coupled to the first node and a second terminal electrically coupled to the voltage supply line; and
a resistor having a first terminal electrically coupled to the first node and a second terminal electrically coupled to the voltage reference line.

2. The protection circuit of claim 1 wherein the control region of the transistor device is the base of a bipolar transistor.

3. The protection circuit of claim 2 wherein the first contact region of the transistor device is a collector and the second contact region is an emitter of an npn transistor.

4. The protection circuit of claim 2 wherein the first contact region of the transistor device is an emitter and the second contact region is a collector of a pnp transistor.

5. The protection circuit of claim 1 wherein the control region of the transistor device is the gate of an FET transistor.

6. The protection circuit of claim 2 wherein the first contact region is a source and the second contact region is a drain of the FET transistor.

7. The protection circuit of claim 2 wherein the first contact region is a drain and the second contact region is a source of the FET transistor.

8. The protection circuit of claim 1 wherein the voltage reference line is electrically coupled to a ground.

9. The protection circuit of claim 1 wherein the resistor is an active or passive component.

10. The protection circuit of claim 1 wherein the resistor has a value between 5 Kohms and 50 Kohms.

11. The protection circuit of claim 1 wherein the capacitor is an MOS transistor having its source and drain coupled together, and its gate coupled to the voltage supply line.

12. The protection circuit of claim 1 wherein the capacitor has a value between 200 fempto farads and 10 pico farads.

13. The protection circuit of claim 1 wherein an RC time constant for the protection circuit is between 1 and 500 nanoseconds.

14. The protection circuit of claim 1 further comprising a diode having an anode and cathode, the diode anode electrically coupled to the voltage reference line and the diode cathode electrically coupled to the voltage supply line.

15. A protection circuit to protect an electronic circuit from an electrostatic discharge or voltage pulse, the protection circuit comprising:
a transistor having an emitter region, a base region, and a collector region, the collector region of the bipolar transistor electrically coupled to a voltage supply line, the emitter region of the bipolar transistor electrically coupled to a voltage reference line, and the base region of the bipolar transistor electrically coupled to a first node;
a capacitor having a first terminal electrically coupled to the first node and a second terminal electrically coupled to the voltage supply line; and
a resistor having a first terminal electrically coupled to the first node and a second terminal electrically coupled to the voltage reference line.

16. The protection circuit of claim 15 wherein the voltage reference line is electrically coupled to a ground.

17. The protection circuit of claim 15 wherein the resistor is an active or passive component.

18. The protection circuit of claim 15 wherein the resistor has a value between 5 Kohms and 50 Kohms.

19. The protection circuit of claim 15 wherein the capacitor has a value between 200 fempto farads and 10 pico farads.

20. The protection circuit of claim 11 wherein the capacitor is an MOS transistor having its source and drain coupled together, and its gate coupled to the voltage supply line.

21. The protection circuit of claim 15 wherein an RC time onstant for the protection circuit is between 1 and 500 nanoseconds.

22. A protection circuit to protect an electronic circuit from an electrostatic discharge or voltage pulse, the protection circuit comprising:
a transistor having an emitter region, a base region, and a collector region, the collector region of the bipolar transistor electrically coupled to a voltage supply line, the emitter region of the bipolar transistor electrically coupled to a voltage reference line, and the base region of the bipolar transistor electrically coupled to a first node;
a capacitive element having a first terminal electrically coupled to the first node and a second terminal electrically coupled to the voltage supply line;
a resistive element having a first terminal electrically coupled to the first node and a second terminal electrically coupled to the voltage reference line; and
a diode having an anode and a cathode, the anode electrically coupled to the voltage reference line and the cathode electrically coupled to the voltage supply line.

23. The protection circuit of claim 22 wherein the voltage reference line is electrically coupled to a ground.

24. The protection circuit of claim 22 wherein an RC time constant for the protection circuit is between 1 and 500 nanoseconds.

25. The protection circuit of claim 22 wherein the diode is a transistor configured as a p-n junction.

26. An integrated circuit having an electrostatic discharge or voltage pulse protection circuit, the integrated circuit comprising:
a voltage supply line and a voltage reference line, a bipolar lateral transistor having an emitter region, a base region, and a collector region, the collector region of the bipolar transistor electrically coupled to the voltage supply line, the emitter region of the bipolar transistor electrically coupled to the voltage reference line, and the base region of the bipolar transistor electrically coupled to a first node;
a capacitive element having a first terminal electrically coupled to the first node and a second terminal electrically coupled to the voltage supply line; and
a resistive element having a first terminal electrically coupled to the first node and a second terminal electrically coupled to the voltage reference line such that an RC time constant for the resistor and the capacitor in combination is between 1 and 500 nanoseconds.

27. The protection circuit of claim 26 further comprising a diode having an anode and cathode, the anode electrically coupled to the voltage reference line and the cathode electrically coupled to the voltage supply line.

28. The protection circuit of claim 27 wherein the diode is a transistor configured as a p-n junction.

29. The protection circuit of claim 26 wherein the voltage reference line is electrically coupled to a ground.

30. An integrated circuit structure for over-voltage protection, the integrated circuit structure comprising:
a p-type substrate;
an n-well region formed in the p-type substrate;
a p-well region formed in the n-well;
a first n-type region contacting the p-well region, forming an emitter region of an npn transistor;
a second n-type region contacting the n-well region, forming a collector region of the npn transistor;
a first p-type region coupled to the p-well region, forming a base region of the npn transistor;
a resistive element having a first terminal electrically coupled to the first p-type region and a second terminal electrically coupled to a common voltage reference line; and
a capacitive element having a first terminal electrically coupled to the first p-type region and a second terminal electrically coupled to a power voltage line.

31. The protection circuit of claim 30 further comprising a second p-type region coupled to the n-well region, forming an anode region of a diode and a third n-type region contacting the n-well region, forming a cathode region of the diode.

32. The protection circuit of claim 30 wherein the second n-type region and the third n-type region are the same region.
